(19) United States
(12) Patent Application Publication
(10) Pub. No.: US 2025/0263191 A1
(43) Pub. Date: Aug. 21, 2025

(54) STRAP CUTTER CARRIAGE AND METHOD FOR CUTTING A STRAP

(71) Applicant: SIDEL PARTICIPATIONS, OCTEVILLE-SUR-MER (FR)

(72) Inventors: Guillaume BORNARD, CORCELLES-LES-CITEAUX (FR); Florent POITOUT, CORCELLES-LES-CITEAUX (FR); Jérôme SERGENT, CORCELLES-LES-CITEAUX (FR)

(21) Appl. No.: 19/052,474

(22) Filed: Feb. 13, 2025

(30) Foreign Application Priority Data
Feb. 15, 2024 (FR) FR2401476

(51) Int. Cl. B65B 69/00; B25D 5/00; B26D 7/00

(52) U.S. Cl. CPC B65B 69/0025; B25D 5/00; B26D 7/0006

(57) ABSTRACT

Provided is a strap cutter carriage for cutting a strap and methods for cutting a strap. The strap cutter carriage includes a displacement chassis and a cutting chassis (204). It also includes a separating tongue fixedly mounted on the cutting chassis, the tongue including a ramp surface having a front end configured to slide between a strap and a reference surface of a bundle of elements such that the ramp surface separates the strap from the reference surface during the displacement of the displacement chassis. Also included is a guide fixedly mounted on the cutting chassis to guide the front end of the tongue relative to the reference surface, a presence detector for a strap which is in contact with the tongue, and a cutting blade configured to cut the strap.

### CROSS-REFERENCE TO RELATED APPLICATIONS

This application claims the benefit of French Application No. FR2401476, filed Feb. 15, 2024, the entire contents of which are hereby incorporated herein by reference.

### TECHNICAL FIELD OF THE INVENTION

The present invention relates to the field of packaging bundles of elements surrounded by a strap and more particularly to cutting the strap.

The present invention relates more particularly to a strap cutter carriage, a machine comprising such a carriage and a method for cutting a strap surrounding a bundle of elements, such as a bundle of boxes in the form of flat sheets.

### TECHNOLOGICAL BACKGROUND OF THE INVENTION

Carriages for cutting a strap surrounding a bundle of elements are available, comprising:
a cutting means which is configured to cut the strap,
a locating means which is configured to locate the strap to be cut and thus guide the cutting means as far as the strap.

Conventionally, the locating means is in the form of a camera enabling the strap to be identified visually in order to locate it. Such a locating means has certain drawbacks. More specifically, the identification of the strap is visual and depends on the physical aspect thereof, in particular its difference in colour relative to the surface of the element retained by the strap. Thus in the case of a colour which is close or identical to that of the strap and that of the reference surface of the element, or even in the case of the presence of a coloured band on the surface of the element, the locating means can encounter locating errors or find it impossible to identify the strap. For example, it is very difficult for this type of locating means to identify a white strap on a white surface of the bundle of elements.

The strap makes it possible to hold the different elements against one another, for example cardboard cutouts, boxes, in particular in an unfolded state, in order to transport them from a first zone, for example from a pallet, to a second zone, for example a magazine for loading elements, without an element falling off during transport.

Conventionally the strap is cut before an extraction machine, which is disclosed for example in the document WO 2017072428, moves the elements from the pallet in order to position them in a storage magazine of a processing machine of the case packer or case former type, folding each box from the flat state thereof into the assembled state thereof.

The cutting means is thus generally a device which is independent of the extraction machine which is configured to displace the bundle of elements retained by the strap from the pallet as far as a storage magazine. The use of a plurality of devices or machines involves a significant cost.

The extraction machine is configured to displace the elements:
per unit, one element after the other by means of a suction cup device, which has a substantially greater extraction time and involves a significant production cost, or
per bundle, by dividing the piles into a plurality of bundles of elements, by a gripping means in the form of a vice, which also requires a means for separating different bundles of elements which is configured to separate two bundles of elements from one another by being interposed between the two.

One conceivable solution is to use the strap in order to extract the bundles of elements from the pile, for example in the form of a pile of flat boxes, but this requires the use of a second strap intersecting perpendicularly with the first strap which involves, on the one hand, two cuts of the straps and, on the other hand, an increase in the number of straps used and thus an increase in the total cost.

There are extraction machines, such as that described in the document WO 2017001749, comprising a clamp which takes the form of a controlled vice which is able to close once it surrounds the strap. The strap thus has to be previously located, in particular by a camera, in order to be able to be clamped. The machine also comprises a cutting means comprising a mobile cutting blade which cuts the strap when it is captured in said vice. The machine thus has a clamp to grasp the strap and a cutting means which cuts off the strap while it is grasped by the clamp. The cutting means further comprises a sharp lip to be passed between the strap and the bundle of elements, this lip potentially forming a jaw of the clamp. However, this machine requires the strap to be precisely located before being clamped, which can pose problems in the case of a strap of a similar colour to that of the reference surface of the bundle of elements, or even according to the external light which can affect the visibility of the strap.

Thus there is a need for a simpler and less costly system, using a single strap to retain a bundle of elements and a cutting means having a minimized cost and versatile operation, enabling it to be adapted to any type of strap.

### SUMMARY OF THE INVENTION

The invention provides a solution for cutting a strap surrounding a bundle of elements by proposing a strap cutter carriage.

A first aspect of the invention relates to a strap cutter carriage for cutting a strap surrounding a bundle of elements comprising:
a displacement chassis,
a cutting chassis which is mobile relative to the displacement chassis,
a separating tongue which is fixedly mounted on the cutting chassis and which comprises a ramp surface extending from a front end to a rear end of the separating tongue, the front end being configured to slide between a strap and a reference surface of the bundle of elements such that the ramp surface separates the strap from the reference surface of the bundle of elements during the displacement of the displacement chassis,
a guide which is fixedly mounted at the front on the cutting chassis to guide and adapt the orientation of the front end of the separating tongue relative to the reference surface in order to facilitate the insertion of the separating tongue between the strap and the reference surface,
a presence detector for a strap which is configured to detect the strap when it is in contact with the ramp surface of the separating tongue and
a cutting blade which is configured to cut the strap.

The strap cutter carriage according to the invention advantageously makes it possible to dispense with an additional means for locating a strap. In other words, it is not necessary to locate the strap prior to grasping the bundle of elements. More specifically the strap cutter carriage enables blind displacement, i.e. without a precise locating of the strap, prior to the detection of the strap on the separating tongue. The separating tongue is interposed between the strap and the reference surface of a bundle of elements and thus permits the detection of the strap by the presence detector. More specifically, since the strap is still positioned around the bundle of elements, the front end of the separating tongue slides over the reference surface due to the guide and the cutting chassis which is articulated relative to the displacement chassis. The guide and the articulation of the cutting chassis make it possible to orientate the separating tongue according to an angle relative to the reference surface. Moreover, the displacement chassis makes it possible to displace the cutting chassis and thus the separating tongue over this reference surface, by being adapted to its shape whether it is concave or convex. Due to the use of the presence detector, the detection of the strap is implemented by a mechanical contact of the strap with the ramp surface of the tongue which identifies the strap, regardless of its colour, its material, in particular relative to the use of a locating means in the form of a camera according to the prior art.

Moreover, the presence of the ramp surface of the separating tongue makes it possible to insert the separating tongue between the strap and the reference surface of the bundle of elements and to separate the strap from this reference surface and thus to tension the strap. When the strap is tensioned, this facilitates the cutting thereof by the cutting blade. Moreover, when it is tensioned the strap has the advantage of improving the tightening of the strap about a bundle of elements, thus being able to permit an extraction machine to grasp the bundle of elements as a whole (without dividing into sub-bundles) in order to extract the bundle of elements from a pallet without having the need for a second strap or a gripping means in the form of a vice and a separating means.

Such a strap cutter carriage thus makes it possible to reduce significantly the cost for extracting from a pallet a bundle of elements surrounded by a strap. It is also highly reliable and permits the capture of all types of strap, which makes it very versatile.

Advantageously, the cutting chassis is mobile in rotation according to a first axis of rotation relative to the displacement chassis.

According to one example, the displacement chassis comprises means for displacement in translation according to an axis of translation perpendicular to the first axis of rotation.

Advantageously, the strap cutter carriage comprises a pushing means which is mounted between the displacement chassis and the cutting chassis and which is configured to pivot the cutting chassis between a first position and a last position, the pushing means exerting a force on the cutting chassis toward the last position such that the front end of the separating tongue is in contact with the reference surface of the bundle of elements during the displacement of the strap cutter carriage. Such a feature makes it possible to control the displacement of the cutting chassis relative to the displacement chassis and thus to control the position of the separating tongue relative to the reference surface of the bundle of elements.

According to a first variant of the pushing means, the pushing means is a compensating actuator, preferably a jack. The jack can be in the form of a pneumatic, hydraulic or electric jack.

According to one example, the pushing means is a linear actuator, for example a jack, which is configured to pivot the cutting chassis relative to the displacement chassis according to a first axis of rotation in a controlled manner. A “controlled manner” is understood to mean that the pushing means applies a force which is controlled according to the force of the separating tongue and guides it over the reference surface of the bundle of elements. In other words, the force exerted on the separating tongue is determined according to the orientation of the cutting chassis and the reference surface and according to the distance of the displacement chassis relative to the reference surface.

According to a second variant of the pushing means, the pushing means is a spring.

Preferably, the strap cutter carriage comprises a blocking actuator which is movably mounted on the cutting chassis and can be activated after the strap has been detected by the presence detector, the blocking actuator comprising a block which is configured to clamp the strap against the separating tongue. Such a feature makes it possible to hold the strap in position, on the one hand, during the displacement of the strap cutter carriage and, on the other hand, to facilitate the cutting of the strap by the cutting blade and, in particular, by holding the strap to remove it easily from the bundle of elements once the strap has been cut.

According to a first variant of the separating tongue, the separating tongue comprises a concave face opposite the cutting chassis of the strap cutter carriage. Such a feature makes it possible to facilitate the sliding of the front end of the tongue below the strap surrounding the bundle of elements.

According to a second variant of the separating tongue, the separating tongue comprises a convex face opposite the cutting chassis of the strap cutter carriage. Such a feature makes it possible to avoid damaging the reference surface during the displacement of the strap cutter carriage when the separating tongue is in contact with the reference surface.

Preferably, the guide comprises a front edge which is arranged at the front of the front end of the separating tongue. Such a feature makes it possible to optimize the guiding of the tongue during the displacement of the strap cutter carriage.

Advantageously, the separating tongue is elastically deformable. Such a feature makes it possible to facilitate the sliding of the separating tongue below the strap surrounding the bundle of elements. In particular, the separating tongue can be elastically folded, such as a spring blade, in order to permit one part of the separating tongue, extending from its front end, to slide over the reference surface of the bundle of elements and to be inserted below the strap (between the strap and the reference surface) by exerting a pressure on the opposing end of the tongue, toward the reference surface of the reference bundle.

Advantageously, the separating tongue is produced from spring steel and preferably spring steel XC100, i.e. it has a carbon content of 1%.

Advantageously, the presence detector is mounted on the cutting chassis.

Advantageously, the cutting chassis is only mobile in rotation relative to the displacement chassis according to a first axis of rotation; the cutting chassis comprises a delimiting arm for pivoting the cutting chassis which is mounted so as to be mobile in rotation:
relative to the displacement chassis by means of a shaft centred on the first axis of rotation, and
relative to the cutting chassis by means of a second axis of rotation; the delimiting arm comprising at least one stop for the last position of the cutting chassis.

Such a feature makes it possible to control the pivoting of the cutting chassis relative to the displacement chassis. This makes it possible to exert a pressure on the tongue to permit the front end thereof to slide below the strap.

According to one example in which the strap cutter carriage also comprises the pushing means in the form of a jack, the second axis of rotation corresponds to the connection between the jack and the cutting chassis, the jack comprising at its other end a pivot connection according to a third axis with the displacement chassis.

Preferably, the delimiting arm comprises an aperture which is delimited by the last position stop and a first position stop of the cutting chassis, the aperture cooperating with a blocking stud which is fixedly mounted on the cutting chassis so as to limit the rotation of the cutting chassis between the first position and the last position. Such a feature makes it possible to limit the pivoting of the cutting chassis relative to the displacement chassis between a first and a last position. Moreover, this makes it possible to reduce the mounting play of the first axis of rotation between the displacement chassis and the cutting chassis.

Preferably, the presence detector comprises:
a pendulum arm which is mounted pivotably movably on the cutting chassis according to a third axis of rotation between a resting position and a final position and which comprises an arm extending perpendicularly to the third axis of rotation by having a lower end opposing the third axis of rotation which in the resting position of the pendulum arm protrudes beyond the separating tongue and
a position change sensor of the pendulum arm emitting a presence detection signal when the pendulum arm is located in a pushed position between the resting position exclusively and the final position inclusively.

Due to the combination of a pendulum arm and a position change sensor of the pendulum arm, such a feature makes it possible to simplify the precision of the mechanical detection of the strap.

Advantageously, the guide comprises groups of at least one rotating roller relative to the cutting chassis, which are parallel with one another and form the bearing zone of the guide. Such a feature makes it possible to facilitate the displacement of the strap cutter carriage on the reference surface of the bundle of elements.

Preferably, the cutting blade comprises a cutting edge which is arranged opposite the separating tongue and which is mounted so as to be mobile in translation on the cutting chassis between a resting position and a cutting position, according to which:
in the resting position, the cutting blade is remote from the separating tongue, and
in the cutting position, the cutting blade is in contact with the separating tongue or passes through the tongue.

Advantageously, the separating tongue comprises an opening and in the cutting position the cutting blade passes through the opening of the separating tongue. In the example according to which the strap cutter carriage comprises a pushing means, the pushing means also comprises a slot or an opening passed through by the cutting blade in the cutting position of the blade.

According to a variant, the cutting blade is mounted so as to be mobile in translation on the cutting chassis between a resting position and a cutting position and comprises a cutting edge, the cutting blade being displaced in a plane which is contiguous with a lateral edge of the tongue according to which:
in the resting position, the cutting edge is closer to the displacement chassis than the lateral edge of the cutting blade, and
in the cutting position, the cutting edge is further away from the displacement chassis than the lateral edge of the cutting blade.

A second aspect of the invention relates to a separating tongue for a strap cutter carriage according to the first aspect of the invention, the separating tongue being configured to be fixedly mounted on a cutting chassis and comprising a ramp surface extending from a front end to a rear end of the separating tongue, the front end being configured to slide between a strap and a reference surface of a bundle of elements such that the ramp surface separates the strap from the reference surface of the bundle of elements during the displacement of the displacement chassis.

Advantageously, the separating tongue comprises a concave face opposite the cutting chassis.

Preferably, the separating tongue is produced from spring steel and preferably has a carbon content of 1%.

A third aspect of the invention relates to a method for cutting a strap surrounding a bundle of elements in order to hold them together, by a strap cutter carriage according to the first aspect of the invention, comprising the following steps:
positioning the strap cutter carriage opposite a zone of a reference surface of a bundle of elements upstream of the strap,
displacing the strap cutter carriage to the front, according to an axis of translation, by sliding the guide over the reference surface, causing:
   the pivoting of the cutting chassis relative to the displacement chassis such that the front end of the separating tongue is in contact with the reference surface of the bundle of elements as a function of the contact of the guide with the separating tongue,
   the sliding of the front end of the separating tongue between the strap and the reference surface of the bundle of elements, and
   the sliding of the ramp surface of the separating tongue below the strap and over the reference surface of the bundle of elements until the strap has been detected by the presence detector,
cutting the strap with the cutting blade.

Advantageously, the strap cutter carriage comprises a pushing means which is mounted between the displacement chassis and the cutting chassis, and the pivoting of the cutting chassis relative to the displacement chassis implemented by the action of the pushing means having a pressure which is controlled as a function of the force exerted by the guide on the reference surface of the bundle of elements, such that the front end of the separating tongue is in contact with the reference surface of the bundle of elements.

Preferably, the strap cutter carriage comprises a blocking actuator which is movably mounted on the cutting chassis, the method for cutting comprises:
after the strap has been detected by the presence detector and before the step of cutting, a step of blocking the strap by the displacement of a block of the blocking actuator from a resting position, according to which the block is separated from the strap, as far as a clamping position of the strap against the separating tongue, by applying a force to the strap against the ramp surface of the separating tongue, and
after the step of cutting, a step of displacing the strap cutter carriage causing the removal of the strap from the bundle of elements, the strap being clamped between the block of the blocking actuator and the separating tongue,
after the step of displacing the strap cutter carriage, a step of disposing of the strap in a container, by displacing the strap cutter carriage above the container and displacing the block of the blocking actuator from its clamping position into its resting position.

Advantageously, before the step of displacing the strap cutter carriage opposite a zone, the method for cutting comprises a step of identifying a positioning marker of the reference surface of the bundle of elements, the zone being determined according to the placement of the positioning marker.

Advantageously, the step of identifying the positioning marker is implemented by a marker reader such as a bar code reader or QR code reader which is printed on the reference surface of the bundle of elements.

Advantageously, the method for cutting comprises a step of transmitting information relative to non-detection when the strap cutter carriage is displaced in translation beyond a predetermined position and/or when the presence detector has not detected a strap.

A fourth aspect of the invention relates to a machine comprising:
a robot which comprises a mobile gripping head which is configured to grasp a bundle of elements,
a strap cutter carriage according to the first aspect of the invention, the strap cutter carriage being mounted so as to be mobile in translation relative to the gripping head,
an actuator which is mounted on the gripping head to displace in translation the strap cutter carriage on the gripping head.

The machine according to the invention makes it possible to displace a bundle of elements surrounded by a strap due to the presence of the gripping head, and makes it possible to cut the strap due to the integration of a strap cutter carriage according to the first aspect of the invention. The combination of a gripping head and a carriage in the same machine makes it possible to obtain a versatile machine having a minimized bulk.

Advantageously, the robot comprises a base and an articulated arm which is movably mounted on the base, the gripping head being movably mounted on the articulated arm.

Preferably, the gripping head comprises a principal body and gripping feet which are fixedly mounted on a second surface of the principal body to grasp the reference surface of the bundle of elements.

Advantageously, each gripping foot of the principal body of the gripping head of the machine comprises a suction cup which is arranged at the end thereof.

Advantageously, the gripping head of the robot comprises at least one guide rail which is arranged in the principal body and the cutting chassis of the strap cutter carriage comprises guide wheels which are received in the rail of the gripping head such that the cutting chassis is moved in translation relative to the gripping head by means of the actuator.

A fifth aspect of the invention relates to an assembly comprising a gripping head, comprising:
a principal body,
the strap cutter carriage according to the first aspect of the invention with or without the different optional or preferred features, the strap cutter carriage being mounted so as to be mobile in translation on the principal body of the assembly, and
an actuator for displacing the strap cutter carriage relative to the principal body of the gripping head.

The invention and its various applications will be understood more clearly by reading the following description and examining the accompanying figures.

### BRIEF DESCRIPTION OF THE FIGURES

Further advantages and features of the invention will become apparent by reading the following description which is illustrated by the figures and in which:

FIG. 1 is a schematic view of a machine comprising a robot and a strap cutter carriage according to the invention, in a first position of a gripping head of the robot relative to a base of the robot, during a step of positioning a strap cutter carriage relative to a bundle of elements of a method according to which the gripping head of the robot is in a remote position relative to the bundle of elements, and a cutting chassis of the strap cutter carriage is in a first position relative to a displacement chassis of the strap cutter carriage;

FIG. 2 is a schematic view of the machine during the step of positioning the strap cutter carriage according to FIG. 1 according to which the gripping head has been displaced into a contact position relative to the bundle of elements and the cutting chassis has been displaced into an intermediate position relative to the displacement chassis of the strap cutter carriage;

FIG. 3 is a schematic view of the machine during a step of displacing the strap cutter carriage relative to the gripping head of the robot according to which the strap cutter carriage has been displaced relative to the gripping head of the robot and is shown in an insertion position relative to the strap of the bundle of elements;

FIG. 4 is a schematic view of the machine during the step of displacing the strap cutter carriage according to FIG. 4 according to which the strap cutter carriage has been displaced into a stop position relative to the strap of the bundle of elements;

FIG. 5 is a schematic view of the machine during a step of blocking the strap according to which a blocking actuator is shown in a clamping position relative to the strap cutter carriage, the blocking actuator being shown in a resting position in FIGS. 1 to 4;

FIG. 6 is a schematic view of the machine in a second position of the gripping head relative to the base of the robot, after a step of transporting the bundle of elements, the strap cutter carriage being in the same position as in FIG. 5;

FIG. 7 is a schematic view of the machine during a step of cutting the strap according to which a cutting blade of the strap cutter carriage is in a cutting position, the cutting blade being shown in a resting position in FIGS. 1 to 6;

FIG. 8 is a schematic view according to FIG. 7, during a step of removing the strap according to which the cutting blade is returned to its resting position, the blocking actuator remains in its clamping position, the strap is cut and the bundle of elements is remote relative to the gripping head of the robot;

FIG. 9 is a side view of the strap cutter carriage according to an exemplary embodiment of the invention;

FIG. 10 is a side view of the strap cutter carriage according to a second exemplary embodiment of the invention.

### DETAILED DESCRIPTION

An exemplary embodiment of a strap cutter carriage according to the invention and an exemplary embodiment of a machine comprising a robot and an example of the strap cutter carriage are described in detail hereinafter, with reference to the accompanying drawings. These examples illustrate the features and advantages of the invention.

Unless specified to the contrary, an identical element appearing in the various figures has a single reference sign.

The invention relates to strap cutter carriage 200 which is configured to cut a strap 32 surrounding a bundle of elements 30. According to a further aspect, the invention further relates to an assembly comprising a gripping head 120 comprising:
a principal body 122 on which the strap cutter carriage 200 is movably mounted, and
an actuator for displacing the strap cutter carriage 200 relative to the principal body 122.

The invention also relates to a machine 10 comprising the assembly and a robot 100 comprising the gripping head 120 which is mounted on an articulated arm 130 of the robot 100 to displace the gripping head 120.

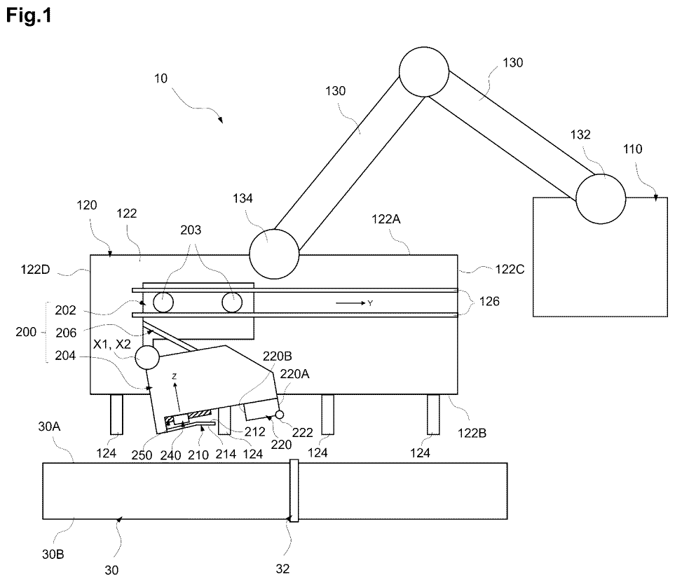

As illustrated in FIGS. 1 to 8, the machine 10 thus comprises:
the robot 100 comprising:
   a base 110
   the gripping head 120 which is movably mounted relative to the base 110, and
   an articulated arm 130 connecting the gripping head 120 to the base 110 and extending between a first pivot connection 132 with the base 110 and a second pivot connection 134 with the gripping head 120;
the strap cutter carriage 200 which is movably mounted relative to the gripping head 120 of the robot 100 and comprising:
   a displacement chassis 202,
   a cutting chassis 204 which is movably mounted relative to the displacement chassis 202; and
the actuator (not shown) which is mounted on the gripping head 120 to displace in translation the strap cutter carriage 200 on the gripping head 120.

More particularly, the principal body 122 of the gripping head 120 comprises:
a first face 122A and a second face 122B opposing the first face, and
a front face 122C and a rear face 122D opposing the front face 122C, the front and rear faces 122C, 122D connecting the first and second faces 122A, 122B to one another.

In the embodiments, the second pivot connection 134 of the articulated arm 130 is arranged in the region of the first face 122A of the principal body 122 of the gripping head 120. The gripping head 120 comprises gripping feet 124 which are fixedly mounted on the second face 122B of the principal body 122. The gripping feet are configured to grasp the reference surface 30A of the bundle of elements 30.

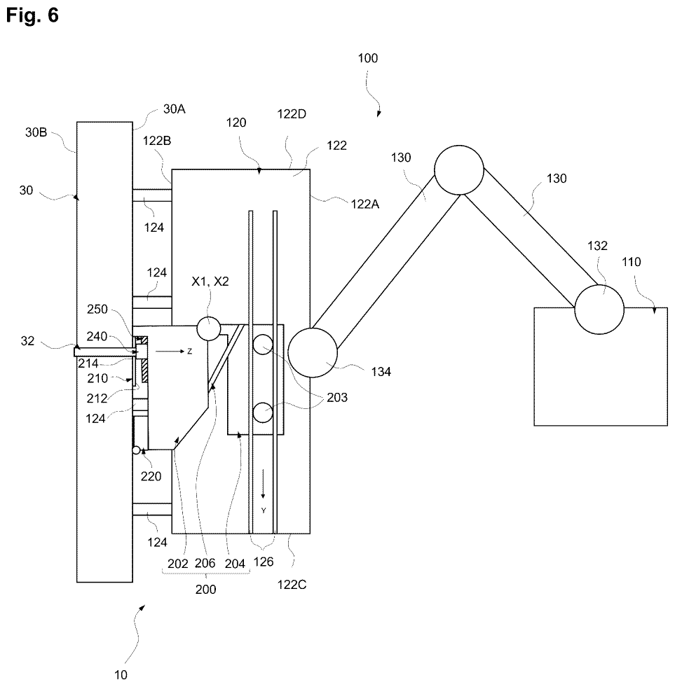

The gripping head 120 of the robot 100 is pivotably mobile relative to the base 110 between a plurality of positions, including:
a first position, shown in FIGS. 1 to 5, according to which the gripping head 120 extends substantially horizontally such that the first and second faces 122A, 122B extend substantially horizontally and
a second position, shown in FIGS. 6 to 8, according to which the gripping head 120 extends substantially vertically such that the front and rear faces 122C, 122D extend substantially vertically and the rear face 122D is arranged above the front face 122D.

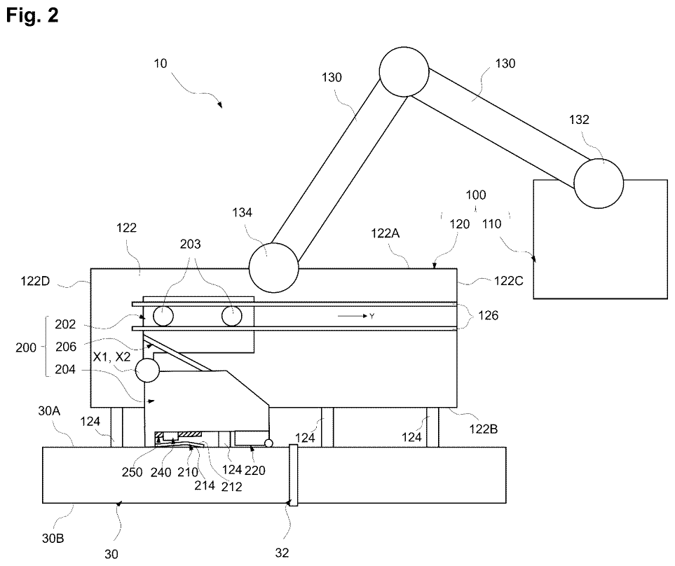

The gripping head 120 of the robot 100 is also pivotably mobile relative to the reference surface 30A of the bundle of elements 30 between:
a remote position, shown in FIG. 1, according to which the second face 122B of the principal body 122 is remote from the reference surface 30A of the bundle of elements 30 by a non-zero distance and
a contact position, shown in FIGS. 2 to 7, according to which the second face 122B of the principal body 122 is substantially parallel to the reference surface 30A and the gripping feet 124 of the gripping head 120 are in contact with the reference surface 30A of the bundle of elements 30.

The gripping head 120 optionally comprises a guide rail 126, in this case a double-rail guide, which is mounted on and arranged in the principal body 122. The strap cutter carriage 200 optionally comprises guide wheels 203 which are mounted in the rail 126 for the movement of the displacement chassis 200 in translation relative to the gripping head 120 by means of the actuator. The guide wheels 203 in this example are each mounted on a corresponding shaft of the displacement chassis 202.

The strap cutter carriage 200 is thus mounted so as to be mobile in translation relative to the gripping head 120 of the robot 100 in the rail 126 of the gripping head 120 between:
an initial position, shown in FIGS. 1 and 2, according to which the cutting carriage 200 is arranged closest to the rear face 122D of the principal body 122 of the gripping head 120, and
a final position, not shown, according to which the cutting carriage is arranged closest to the front face 122C of the principal body 122 of the gripping head 120.

The actuator, not shown, can be an electric motor displacing the cutting carriage 200, for example using a chain and a toothed wheel mounted on the cutting carriage 200, or also can be a jack, for example a pneumatic jack.

The cutting chassis 204 which is movably mounted relative to the displacement chassis 202 is in this case fixed in translation relative to the displacement chassis 202 and is thus also displaced in translation relative to the gripping head 120 by this same actuator. The cutting chassis 204 in this example is only mobile in rotation relative to the displacement chassis 202 according to an axis of rotation X2.

According to a variant, the cutting chassis 204 is displaceable relative to the displacement chassis 202 according to a rotational movement and according to a translation movement. The cutting chassis 204 is thus mobile between:
a first position, shown in FIG. 1, according to which the cutting chassis 204 is inclined toward the rear of the gripping head 120,
a last position, not shown, according to which the cutting chassis 204 is inclined toward the front of the gripping head 120.

The cutting chassis is shown in FIGS. 2 to 8 in an intermediate position according to which the cutting chassis 204 is arranged parallel to the displacement chassis 202 such that the guide 220 is in contact with the reference surface 30A of the bundle of elements 30.

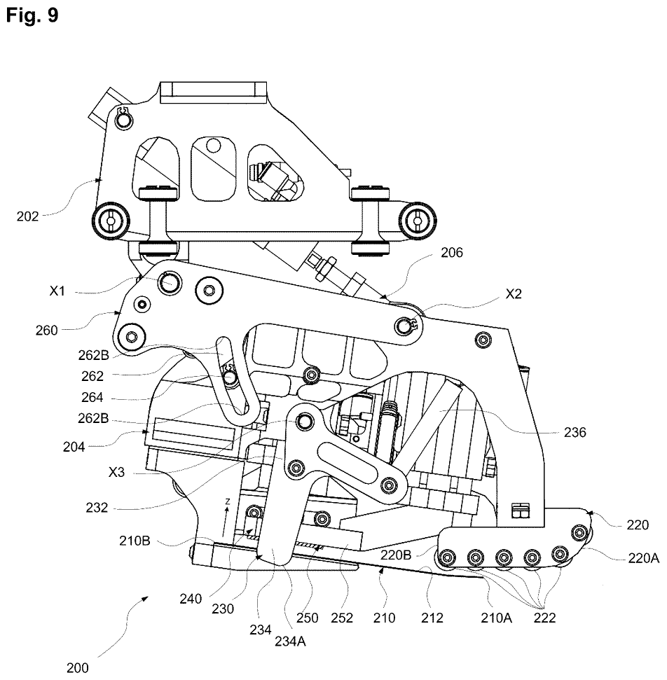

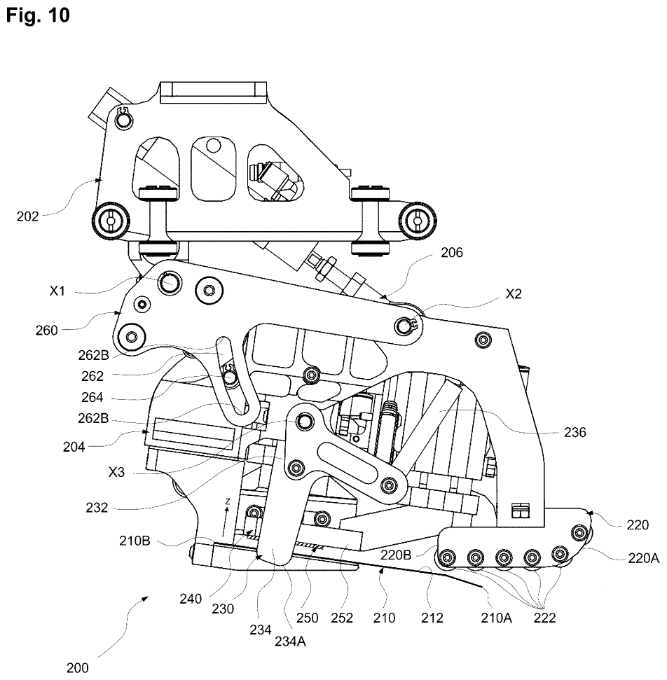

FIG. 9 illustrates a first example of this embodiment of the strap cutter carriage 200 and FIG. 10 illustrates a second example of this embodiment of the strap cutter carriage 200.

As illustrated in FIG. 10, in one possible embodiment, the strap cutter carriage 200 comprises:
a separating tongue 210 which is optionally fixedly mounted on the cutting chassis 204,
a guide 220 which is fixedly mounted at the front on the cutting chassis 204,
a presence detector 230 of the strap 32, and
a cutting blade 240 of the strap 32 which is mounted so as to be mobile in translation on the cutting chassis 204,
a pushing means 206 which is mounted between the displacement chassis 202 and the cutting chassis 204 in order to displace the cutting chassis 204 relative to the displacement chassis 202 between the first and the last position,
a blocking actuator 250 which is movably mounted on the cutting chassis 204 and can be activated after the strap 32 has been detected by the presence detector 230, and
a delimiting arm 260 for pivoting the cutting chassis 204 and which is mounted so as to be mobile in rotation:
   relative to the displacement chassis 202 by means of a shaft centred on the first axis of rotation X1 and
   relative to the cutting chassis 204 by means of a second axis of rotation X2.

“Fixedly mounted” is understood to mean fixed or forming part of the same piece. For example, the separating tongue 210 can be either fixed to the cutting chassis 204 by fixing means, such as nuts, or even form part of the same piece as that of the cutting chassis 204 by welding.

In the embodiments, it is possible to replace the separating tongue 210, in particular when it exhibits signs of wear.

According to a further example, not shown, the separating tongue 210 is articulated on the cutting chassis 204, for example according to an axis of rotation. A further actuator can also be mounted to displace the separating tongue 210 according to an angle which is predetermined or controlled relative to the cutting chassis 204.

### Separating Tongue 210:

More particularly, the separating tongue 210 comprises a ramp surface 212 extending between a front end 210A and a rear end 210B. The front end 210A of the separating tongue 210 is configured to slide between the strap 32 surrounding the bundle of elements 30 and a reference surface 30A of the bundle of elements 30 such that the ramp surface 212 separates the strap 32 from the reference surface 30A of the bundle of elements 30 during the displacement of the displacement chassis 202.

According to a first exemplary embodiment of the cutting carriage 200, as shown in FIGS. 1 to 9, the ramp surface 212 of the separating tongue 210 has a concave face opposite the cutting chassis 204 of the strap cutter carriage 200.

According to a second exemplary embodiment of the cutting carriage 200, as shown in FIG. 10, the cutting carriage 200 is identical to the first example except that the ramp surface 212 of the separating tongue 210 has a convex face opposite the cutting chassis 204 of the strap cutter carriage 200.

According to the first or the second example, the separating tongue 210 can be dependent on the shape of the strap 32 of the bundle of elements 30 to be captured. Further embodiments, not shown, are possible.

Preferably, the separating tongue 210 is elastic. More particularly, the separating tongue 210 is produced from spring steel. Preferably, the separating tongue 210 is produced from spring steel XC100 and has a carbon content of 1%.

### Guide 220:

The guide 220 is configured to guide and adapt the orientation of the front end 210A of the separating tongue 210 relative to the reference surface 30A in order to facilitate the insertion of the separating tongue 210 between the strap 32 and the reference surface 30A of the bundle of elements 30.

The guide 220 comprises a front edge 220A which is arranged at the front of the front end 210A of the separating tongue 210.

The guide 220 comprises groups of at least one rotating roller relative to the cutting chassis 204, which are parallel to one another and form the bearing zone 222 of the guide 220. In this case, the guide 220 comprises six groups and each group comprises a plurality of rotating rollers.

### Presence Detector 230:

The presence detector 230 of a strap 32 is configured to detect the strap 32 when it is in contact with the ramp surface 212 of the separating tongue 210.

The presence detector 230 is mounted on the cutting chassis 204 of the strap cutter carriage 200 and comprises:
a pendulum arm 232 which is movably mounted on the cutting chassis 204 according to a third axis of rotation X3 and comprises an arm 234 which extends perpendicularly to the third axis of rotation X3 and which comprises a lower end 234A opposing the third axis of rotation X3 and
a position change sensor of the pendulum arm 232 emitting a presence detection signal when the pendulum arm 232 is located between the resting position exclusively and the pushed position inclusively.

The position change sensor, not shown, can be in the form of a mechanical sensor, a displacement sensor or a presence sensor.

The pendulum arm 232 of the presence detector 230 is pivotably mobile relative to the cutting chassis between:
a resting position, shown in FIG. 9, according to which the lower end 234A of the arm 234 of the pendulum arm 232 protrudes beyond the separating tongue 210 in a direction perpendicular to the first and second axes of rotation X1, X2, the end 234A being arranged beyond the separating tongue 210,
a final position, not shown, according to which the lower end 234A of the arm 234 of the pendulum arm 232 is located above a plane defined by the ramp surface 212 of the separating tongue 210.

During the translation of the strap cutter carriage 200 toward the final position of the pendulum arm 232 of the presence detector 230, the lower end 234A of the arm 234 of the pendulum arm 232 comes into contact with the strap 32 located on the separating tongue 210 causing the pivoting of the pendulum arm 232 toward its final position and as far as a predetermined pushed position, permitting the position change sensor to emit a signal detecting the presence of the strap 32 and thus stopping the translation of the strap cutter carriage 200. In the pushed position, the lower end 234A of the arm is closer to the third axis of rotation X3 than in the resting position.

### Cutting Blade 240:

The cutting blade 240 is configured to cut the strap 32 previously detected by the presence detector 230.

The cutting blade 240 is mobile in translation relative to the cutting chassis 204 between various positions including:
a resting position according to which the cutting blade 240 is remote from the strap 32 and the separating tongue 210, and
a cutting position in which the cutting blade 240 is either:
   closer to the zone of the reference surface 30A of the bundle of elements 30 covered by the strap 32 in the detected position or
   in contact with the separating tongue 210.

In the examples shown, the cutting blade 240 comprises a cutting edge, the cutting blade 240 being displaced in a plane contiguous with a lateral edge of the separating tongue 210 according to which:
in the resting position the cutting edge is closer to the displacement chassis 202 than the lateral edge of the cutting blade 240, and
in the cutting position the cutting edge is further away from the displacement chassis 202 than the lateral edge of the cutting blade 240 in the region of the strap in the detected position.

According to a further example, the cutting blade 240 is mobile in translation according to a plane passing through the separating tongue 210. In this example, the cutting edge of the cutting blade 240 comes into contact with the cutting blade 240, or the cutting blade 240 passes through an orifice of the separating tongue 210.

In the embodiments, the cutting blade is arranged in a cutting block which is mounted on the cutting chassis 204. The cutting block is thus movably mounted, such that the cutting blade 240 can be replaced in a simplified manner and in complete safety by an operator. For example, the cutting block is mounted on the cutting chassis 204 by fixing means such as nuts.

### Pushing Means 206:

The pushing means 206 is mounted between the displacement chassis 202 and the cutting chassis 204 and is configured to pivot the cutting chassis 204 relative to the displacement chassis between its first position and its last position.

The pushing means 206 exerts a force on the cutting chassis 204 toward the last position such that the front end 210A of the separating tongue 210 is in contact with the reference surface 30A of the bundle of elements 30 during the displacement of the strap cutter carriage 200.

According to a first possible variant of the pushing means 206, as shown in FIG. 9, the pushing means 206 is a compensating actuator, preferably a jack. The jack can be in the form of a pneumatic, hydraulic or electric jack.

According to a second possible variant of the pushing means 206, not shown, the pushing means 206 is a spring.

### Blocking Actuator 250:

According to an exemplary embodiment of the blocking actuator 250, as shown in FIG. 9, the blocking actuator 250 comprises a block 252 which is configured to clamp the strap 32 against the separating tongue 210.

### Delimiting Arm 260:

The delimiting arm 260 comprising at least one stop 262B for the last position of the cutting chassis 204.

The delimiting arm 260 comprises an aperture 262 which is delimited by the last position stop 262B and a first position stop 262A of the cutting chassis 204, the aperture 262 cooperating with a blocking stud 264 which is fixedly mounted on the cutting chassis 204 so as to limit the rotation of the cutting chassis 204 between the first position and the last position.

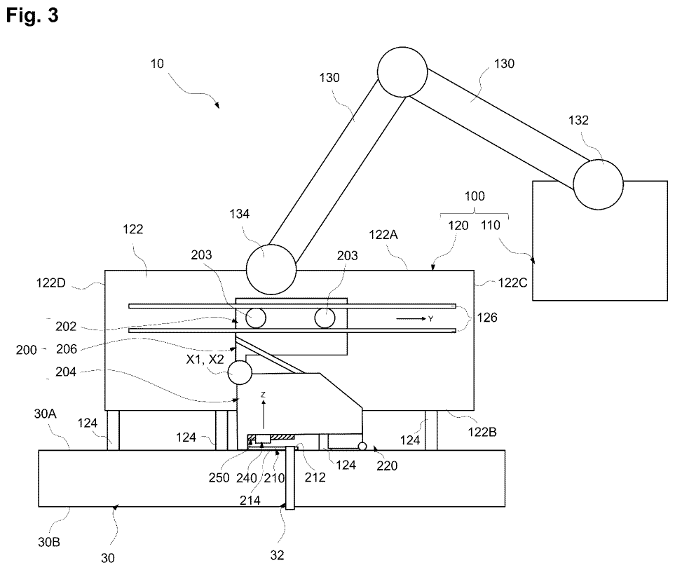

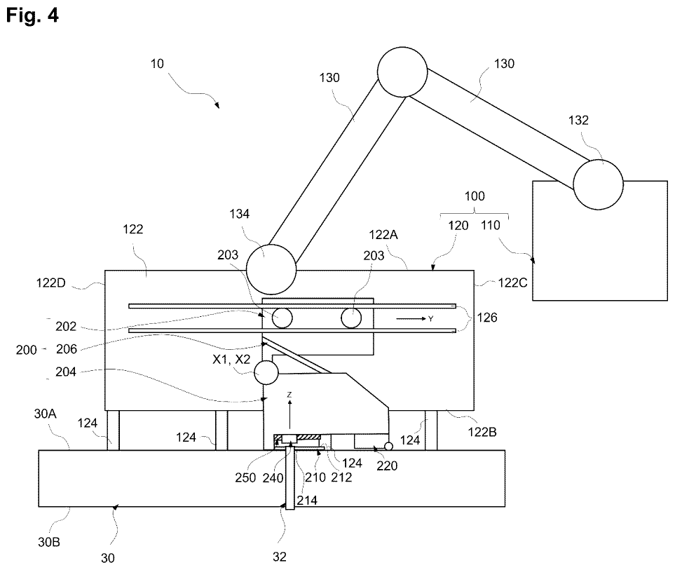

The strap cutter carriage 200 is thus displaced in translation relative to the strap 32 surrounding the bundle of elements 30 with the cutting chassis 204 located in an intermediate position relative to the displacement chassis 202 sliding over the reference surface 30A of the bundle of elements 30 between:
an initial position, then
an insertion position, shown in FIG. 3, according to which the front end 210A of the separating tongue 210 is slid below the strap 32, and a portion of the ramp surface 212 of the separating tongue 210 is arranged between the strap 32 and the reference surface 30A of the bundle of elements 30, then
a stop position, shown in FIG. 4, according to which the cutting blade 240 and the block 252 of the blocking actuator 250 are arranged opposite the strap 32.

FIGS. 1 to 8 show different steps of an example for implementing a method for removing a strap 32 surrounding a bundle of elements 30 implemented by the machine 10. The method for removing by the machine comprises the steps of a method for cutting the strap 32 surrounding the bundle of elements 30 implemented by the strap cutter carriage 200.

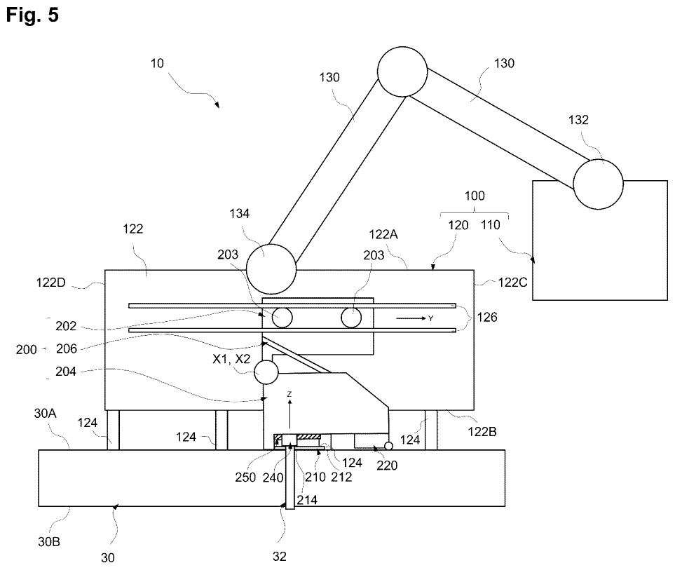

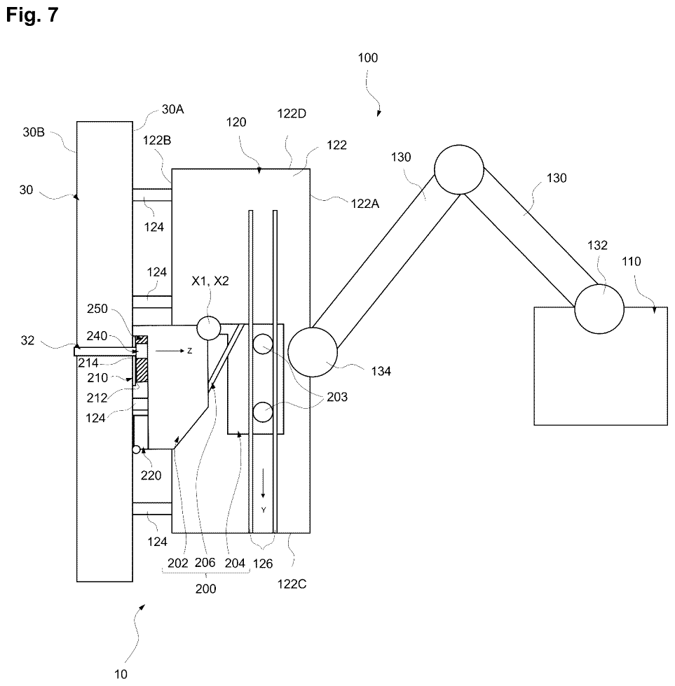

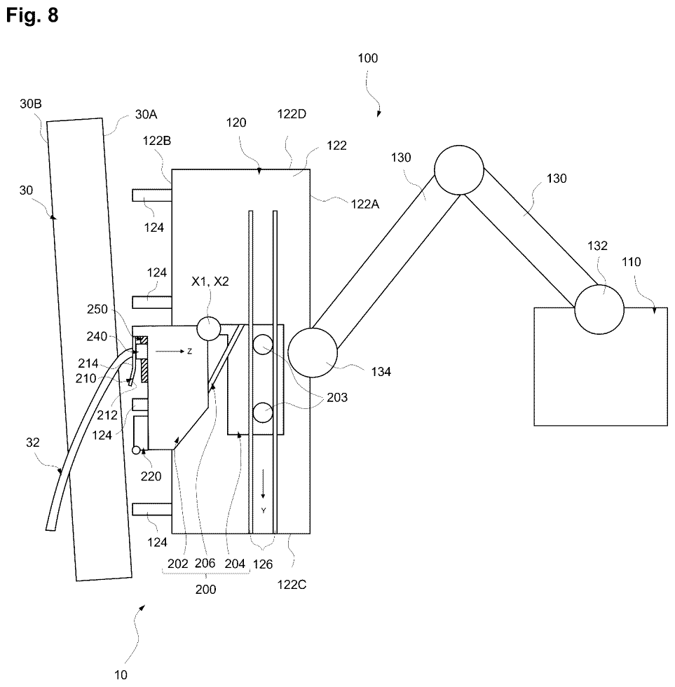

The method for removing comprises, for example, the following successive steps:
identifying a positioning marker of the reference surface 30A of the bundle of elements 30, the identification zone being determined according to the placement of the positioning marker, and thus the marker permits the robot to position the gripping head opposite the reference surface with the cutting carriage 200 in the first position relative to the gripping head, located behind the strap 32. In other words, said strap 32 is in a zone in front (upstream) of the cutting carriage 200, said cutting carriage 200 being in the first position. Thus the precise location of the strap 32 is unknown:
displacement of the gripping head 120 as far as its first position relative to the base 110 of the robot 100 (FIG. 1);
displacement of the gripping head 120 from its remote position to its contact position (step from FIG. 1 to FIG. 2);
positioning of the strap cutter carriage 200 in a first position opposite a zone of the reference surface 30A of the bundle of elements 30 upstream of the strap 32 (step from FIG. 1 to FIG. 2);
displacement of the strap cutter carriage 200 to the front according to an axis of translation Y, by sliding the guide 220 over the reference surface 30A, causing:
   the pivoting of the cutting chassis 204 relative to the displacement chassis 202, such that the front end 210A of the separating tongue 210 is in contact with the reference surface 30A of the bundle of elements 30 as a function of the contact of the guide 220 with the separating tongue 210 (FIG. 2) and the guide 220 is in contact with the reference surface 30A,
   the sliding of the front end 210A of the separating tongue 210 between the strap 32 and the reference surface 30A of the bundle of elements 30 (FIG. 3) and
   the sliding of the ramp surface 212 of the separating tongue 210 below the strap 32 and over the reference surface 30A of the bundle of elements 30 until the strap 32 is detected by the presence detector 230 (FIG. 4);
      blocking of the strap 232 by the displacement of the block 252 of the blocking actuator 250 from its resting position as far as its clamping position, by applying a force on the strap 32 against the ramp surface 212 of the separating tongue 210 (FIG. 5);
      displacement of the gripping head 120 toward its last position as far as a predetermined position, for example according to a quantity of elements in the storage magazine relative to the base 110 of the robot 100 (FIG. 6);
      cutting the strap 32 with the cutting blade 240 (FIG. 7);
      displacement of the strap cutter carriage 200 causing the removal of the strap 32 from the bundle of elements 30, the strap 32 being clamped between the block 252 of the blocking actuator 250 and the separating tongue 210 (FIG. 8);
      optionally the disposal of the strap 32 in a container, by displacing the strap cutter carriage 200 above the container and by displacing the block 252 of the blocking actuator 250 from its clamping position to its resting position (not shown).

The method for removing can also comprise a step of transmitting information relative to non-detection when the strap cutter carriage 200 is displaced in translation beyond a predetermined position and/or when the presence detector 230 has not detected a strap 32.

More particularly, the step of identifying the positioning marker is implemented, for example, by a marker reader such as a bar code reader or QR code reader which is printed on the reference surface 30A of the bundle of elements 30.

More particularly, during the step of displacing the strap cutter carriage 200 to the front, the pivoting of the cutting chassis 204 relative to the displacement chassis 202 is implemented by the action of the pushing means 206 having a pressure which is controlled as a function of the force exerted by the guide 220 on the reference surface 30A of the bundle of elements 30, such that the front end 210A of the separating tongue 210 is in contact with the reference surface 30A of the bundle of elements 30.

1. A strap cutter carriage for cutting a strap surrounding a bundle of elements, the strap cutter carriage comprising:
a displacement chassis;
a cutting chassis that is mobile relative to the displacement chassis;
a separating tongue fixedly mounted on the cutting chassis, wherein the separating tongue comprises a ramp surface extending from a front end to a rear end of the separating tongue, the front end being configured to slide between the strap and a reference surface of the bundle of elements such that the ramp surface separates the strap from the reference surface during displacement of the displacement chassis;
a guide fixedly mounted at the front on the cutting chassis to guide and adapt the orientation of the front end of the separating tongue relative to the reference surface in order to facilitate the insertion of the separating tongue between the strap and the reference surface; a presence detector for a strap, the presence detector configured to detect the strap when the strap is in contact with the ramp surface; and
a cutting blade configured to cut the strap.

2. The strap cutter carriage according to claim 1, further comprising a pushing means mounted between the displacement chassis and the cutting chassis, wherein the pushing means is configured to pivot the cutting chassis between a first position and a last position, the pushing means exerting a force on the cutting chassis toward the last position such that the front end of the separating tongue is in contact with the reference surface of the bundle of elements during the displacement of the strap cutter carriage.

3. The strap cutter carriage according to claim 1, further comprising a blocking actuator movably mounted on the cutting chassis, wherein the blocking actuator is configured to be activated after the strap has been detected by the present detector, the blocking actuator comprising a block configured to clamp the strap against the separating tongue.

4. The strap cutter carriage according to claim 1, wherein the separating tongue comprises a concave face opposite the cutting chassis.

5. The strap cutter carriage according to claim 2, wherein the guide comprises a front edge arranged at the front of the front edge of the separating tongue.

6. The strap cutter carriage according to claim 1, wherein the separating tongue is elastically deformable.

7. The strap cutter carriage according to claim 1, wherein the cutting chassis is only mobile in rotation relative to the displacement chassis according to a first axis of rotation (X1) and wherein the cutting chassis comprises a delimiting arm for pivoting of the cutting chassis,
wherein the cutting chassis is mounted so as to be mobile in rotation:
relative to the displacement chassis by means of a shaft centred on the first axis of rotation (X1) and
relative to the cutting chassis by means of a second axis of rotation (X2); and
wherein the delimiting arm comprises at least one stop for a last position of the cutting chassis.

8. The strap cutter carriage according to claim 7, wherein the delimiting arm comprises an aperture that is delimited by the at least one last position stop and a first position stop of the cutting chassis, the aperture cooperating with a blocking stud fixedly mounted on the cutting chassis so as to limit the rotation of the cutting chassis between the first position and the last position.

9. The strap cutter carriage according to claim 1, wherein the presence detector comprises:
a pendulum arm that is mounted pivotably movably on the cutting chassis according to a third axis of rotation (X3) between a resting position and a final position and which comprises an arm extending perpendicularly to the third axis of rotation (X3) by having a lower end opposing the third axis of rotation (X3), wherein the lower end protrudes beyond the separating tongue when the pendulum arm is in the resting position; and
wherein a position change sensor of the pendulum arm emits a presence detection signal when the pendulum arm is located in a pushed position between the resting position exclusively and the final position inclusively.

10. The strap cutter carriage according to claim 1, wherein the guide comprises groups of at least one rotating roller relative to the cutting chassis, wherein the groups are parallel with one another and form a bearing zone of the guide.

11. A separating tongue for a strap cutter carriage, wherein the separating tongue is configured to be fixedly mounted on a cutting chassis, the separating tongue comprising a ramp surface extending from a front end to a rear end of the separating tongue, wherein the front end is configured to slide between a strap and a reference surface of a bundle of elements such that the ramp surface separates the strap from the reference surface of the bundle of elements during displacement of the displacement chassis.

12. The separating tongue according to claim 11, further comprising a concave face opposite the cutting chassis.

13. The separating tongue according to claim 12, comprising spring steel and a carbon content of 1%.

14. A method for cutting a strap surrounding a bundle of elements by a strap cutter carriage according to claim 1, the method comprising:
positioning the strap cutter carriage opposite a zone of a reference surface of the bundle of elements upstream of the strap;
displacing the strap cutter carriage to a front of the strap, according to an axis of translation (Y), by sliding the guide over the reference surface, causing:
pivoting of the cutting chassis relative to the displacement chassis such that the front end of the separating tongue is in contact with the reference surface of the bundle of elements as a function of the contact of the guide with the separating tongue,
sliding of the front end of the separating tongue between the strap and the reference surface of the bundle of elements, and
sliding of the ramp surface of the separating tongue below the strap and over the reference surface of the bundle of elements until the strap has been detected by the presence detector; and
cutting the strap with the cutting blade.

15. The method according to claim 14, wherein the strap cutter comprises a pushing means mounted between the displacement chassis and the cutting chassis, wherein the pushing means is configured to pivot the cutting chassis between a first position and a last position, the pushing means exerting a force on the cutting chassis toward the last position such that the front end of the separating tongue is in contact with the reference surface of the bundle of elements during the displacement of the strap cutter carriage,
wherein the pivoting of the cutting chassis relative to the displacement chassis is implemented by an action of the pushing means having a pressure that is controlled as a function of the force exerted by the guide on the reference surface, such that the front end of the separating tongue is in contact with the reference surface.

16. The method according to claim 14, wherein the strap cutter carriage comprises a blocking actuator movably mounted on the cutting chassis;
wherein the method further comprises:
after the strap has been detected by the presence detector and before the step of cutting, a step of blocking the strap by the displacement of a block of the blocking actuator from a resting position, according to which the block is separated from the strap, as far as a clamping position of the strap against the separating tongue, by applying a force to the strap against the ramp surface of the separating tongue, and
after the step of cutting, a step of displacing the strap cutter carriage causing the removal of the strap from the bundle of elements, the strap being clamped between the block of the blocking actuator and the separating tongue,
after the step of displacing the strap cutter carriage, a step of disposing of the strap in a container, by displacing the strap cutter carriage above the container and displacing the block of the blocking actuator from a clamping position to a resting position.

17. The method according to claim 14, wherein:
before the step of displacing the strap cutter carriage opposite a zone, identifying a positioning marker of the reference surface of the bundle of elements, wherein the zone is determined according to a placement of the positioning marker.

18. The method according to claim 17, wherein the step of identifying the positioning marker is implemented by a marker reader printed on the reference surface of the bundle of elements.

19. The method according to claim 14, further comprising a step of transmitting information relative to non-detection when: the strap cutter carriage is displaced in translation beyond a predetermined position, the presence detector has not detected a strap, or both.

20. A machine comprising:
a robot comprising a mobile gripping head configured to grasp a bundle of elements;
a strap cutter carriage according to claim 1, the strap cutter carriage being mounted so as to be mobile in translation relative to the gripping head; and
an actuator mounted on the mobile gripping head to displace in translation the strap cutter carriage on the gripping head.

21. The machine according to claim 20, wherein the robot comprises a base and an articulated arm, wherein the arm is movably mounted on the base, the gripping head being movably mounted on the articulated arm.

22. The machine according to claim 20, wherein the gripping head comprises a principal body and gripping feet, wherein the gripping feet are fixedly mounted on a second surface of the principal body to grasp the reference surface of the bundle of elements (30).

23. The machine according to claim 20, wherein:
the gripping head of the robot comprises at least one guide rail arranged in the principal body; and
the cutting chassis of the strap cutter carriage comprises guide wheels received in the guide rail such that the cutting chassis is moved in translation relative to the gripping head by the actuator.
